(19) United States
(12) Patent Application Publication
(10) Pub. No.: US 2013/0334393 A1
(43) Pub. Date: Dec. 19, 2013

(54) DUAL AXIS SOLAR ARRAY TRACKER

(71) Applicant: Bruce Sho Umemoto, Gardena, CA (US)

(72) Inventor: Bruce Sho Umemoto, Gardena, CA (US)

(21) Appl. No.: 13/526,561

(22) Filed: Jun. 19, 2012

(51) Int. Cl. G01S 3/786

(52) U.S. Cl. CPC G01S 3/7861
USPC 248/550

(57) ABSTRACT

There is disclosed a dual axis tracker (100) comprising a support structure (200) for supporting at least two pivotal arms (110) which is adapted for holding at least two solar devices (109); a first actuating structure (300) pivotally mounted to said pivotal arms (110); said first actuating structure (300) comprising a first telescopic boom (305); a first motor (400) connected to said first telescopic boom (305) for powering the telescopic movement of the telescopic boom (305) and thus providing movement for the first actuating structure (300); a second actuating structure (350) disposed transversely relative to the first actuating structure (300) and pivotally mounted to the support structure (200); said structure (350) comprising a second telescopic boom and (305); a second motor (500) connected to said second telescopic boom (305) for powering the telescopic movement of the second telescopic boom (305) and thus providing movement for the second actuating structure (350). The movement of the first actuating structure (300) translates a first motion for the solar devices (109 and 10) and the movement of the second actuating structure (350) translates a second motion for the solar devices (10).

### FIELD OF INVENTION

Embodiments of the claimed invention relate to solar tracking in general, and more particularly dual axis trackers for tracking the sun and other astronomical objects.

### BACKGROUND

It is generally known that solar power offers incomparable advantages over regular power technologies. Effectively, solar energy has become one of the most promising energy sources in providing sustainable energy to meet the industrial and essential needs of the present and future generations.

Solar power systems convert sunlight into electricity with the aid of at least one solar panel, normally a photovoltaic panel (PV) through the photovoltaic effect. In general practice, and mostly in residential areas, the panel is secured on a suitable supporting or mounting means, normally at a fixed angle directed towards the sun in order to harness sunlight. For this type of fixed mounting, the solar panel is completely stationary. Then there are adjustable mounts, at which the angle of the solar panel can be adjusted for slight inclination or restricted to tilting, to account for the high and second angles relative to the position of the sun.

Existing systems using fixed and adjustable mountings as described above would considerably restrict the amount of energy collected, purely because of the various positions of the sun throughout the day. Such limitations have been addressed partially, with the introduction of solar trackers to orient the panels in order to follow the path of the sun throughout the day and thereby providing tracking precision.

Current trackers are typically single axis or dual axis systems. Single axis solar trackers provide only one degree of orientation relative to the position of the sun. Available implementations of single axis trackers provide movement along a single rotational axis, which are generally limited to horizontal, vertical or tilted orientation. Although such capability is a step ahead of the conventional fixed mountings, with the varying climate conditions and seasonal positional changes of the sun, using single axis trackers may not be optimally effective. As a result, the overall efficiency drops gradually. Dual axis trackers however generally allow tracking of the sun based on two rotational axes, i.e. East to West and North to South positions. Having two axes of rotation is particularly advantageous over single axis systems in terms of capturing the maximum amount of sunlight even during seasonal positional changes of the sun.

Another apparent advantage of using dual axis solar trackers is the convenience of using reflecting means such as mirrors. With the aid of reflecting means mounted on the dual axis tracker and being aligned at a predetermined angle adjacent to at least one solar panel, the power output of the solar panel can be substantially increased without the need to increase the number of solar panels. Appreciably, the cost of installation for mirrors can be significantly lesser compared to that of providing additional solar panels. Further, sunlight can be efficiently reflected towards the panels based on more varied or flexible angles considering the dual axis movements compared to that of a single axis movements. The positive attributes as discussed above cannot be achieved using single axis trackers.

Unfortunately, one of the primary drawbacks often associated to dual axis trackers today is being prohibitively expensive than single axis trackers. This is because most existing dual axis trackers require more components or moving parts, for instance a plurality of motors for each solar panel and thus requiring more maintenance. Additionally, dual axis trackers and systems are generally more complicated or complex compared to that of single axis trackers, especially in the event that there is a plurality of solar panels or an array of panels to be oriented. Thus the installation of these complex systems would be rather taxing.

Dual axis trackers and systems for a linked assembly of solar panels or solar arrays require multiple motors and actuating components for movements of each panel. Perceptibly, with the added amount of components, the overall cost will be higher as well as its complexity in view of the operational and installation aspects.

Considering the rapid expansion in solar powered applications worldwide it would be highly desirable to address these issues and at the same time effectively maximizing the amount of sunlight captured for solar power generation. Dual axis tracker devices and systems known to art suffer from one or more than one disadvantages particularly in the areas as discussed above.

Accordingly, there remains a considerable need for solar trackers, systems or methods that can expediently resolve the above-discussed issues.

### SUMMARY OF INVENTION

In one aspect of the claimed invention, there is provided a dual axis tracker (100) comprising: a support structure (200) comprising two horizontal posts (205, 206) and a plurality of vertical posts (201, 202, 203, 204); wherein each end of said horizontal posts (205, 206) are secured to at least one vertical post (201, 202. 203, 204); at least two pivotal arms (110) mounted to the support structure (200) for holding at least two solar devices (10); a first actuating structure (300) pivotally mounted to said pivotal arms (110); said first actuating structure (300 comprising a first telescopic boom (305); a first motor (400) connected to said first telescopic boom (305) for powering the telescopic movement of the telescopic boom (305) and thus providing movement for the first actuating structure (300); a second actuating structure (350) disposed transversely relative to the first actuating structure (300) and pivotally mounted to the support structure (200); said structure (350) comprising a second telescopic boom (305) a second motor (500) connected to said second telescopic boom (305) for powering the telescopic movement of the second telescopic boom (305) and thus providing movement for the second actuating structure (350); wherein the movement of the first actuating structure (300) translates a first motion for the solar devices (109 and 10) and the movement of the second actuating structure (350) translates a second motion for the solar devices (109 and 10).

Various objects, features, aspects, and advantages of the present invention will become more apparent from the following detailed description of preferred embodiments of the invention, along with the accompanying drawings in which like numerals represent like components or members.

The claimed invention is directed to a tracker for providing dual axis movements to an array of solar devices such as solar panels and reflectors with the aid of only two motor units. It is contemplated that the tracker of the claimed invention can be used for astronomical tracking purposes.

### BRIEF DESCRIPTION OF THE DRAWINGS

Features of the claimed invention will be apparent from the following description when read with reference to the accompanying drawings:

FIG. 1 illustrates dual axis tracker for supporting and moving a plurality of solar devices or an array of solar devices in tracking the sun, in one embodiment of the claimed invention;

FIG. 2 illustrates the support structure in accordance with a preferred embodiment of the claimed invention;

FIG. 3 illustrates the actuating structures according to the preferred embodiments of the claimed invention;

FIG. 4 (a) illustrates the pivotal arm in accordance with the preferred embodiments of the claimed invention;

FIG. 4(b) illustrates a section of the pivotal arm in accordance with the preferred embodiments of the claimed invention; and

FIG. 5 illustrates the perpendicular connector in accordance with the preferred embodiments of the claimed invention.

### DETAILED DESCRIPTION

In the following description, reference is made to the accompanying drawings where, by way of illustration, specific embodiments of the invention are shown. It is to be understood that other embodiments may be used as structural and other changes may be made without departing from the scope of the claimed invention. Also, the various embodiments and aspects from each of the various embodiments may be used in any suitable combinations. Accordingly, the drawings and detailed description are to be regarded as illustrative in nature and not as restrictive.

Relative terms such as “upper”, “lower”, “below”, “above” and the likes may be used for ease of description in elucidating the subject matter of the present invention, particularly for describing an element or member's relationship to another member or element.

Embodiments of the claimed invention are directed to a solar tracker having the object of solving the previously discussed drawbacks in a cost effective manner.

Accordingly, the dual axis tracker in accordance with the preferred embodiments of the claimed invention provides orientations in tracking the sun or other astronomical objects for an array of solar devices or tools based on two different axes, the solar devices are linked in a manner such that the synchronized movements can be provided using only two motor units.

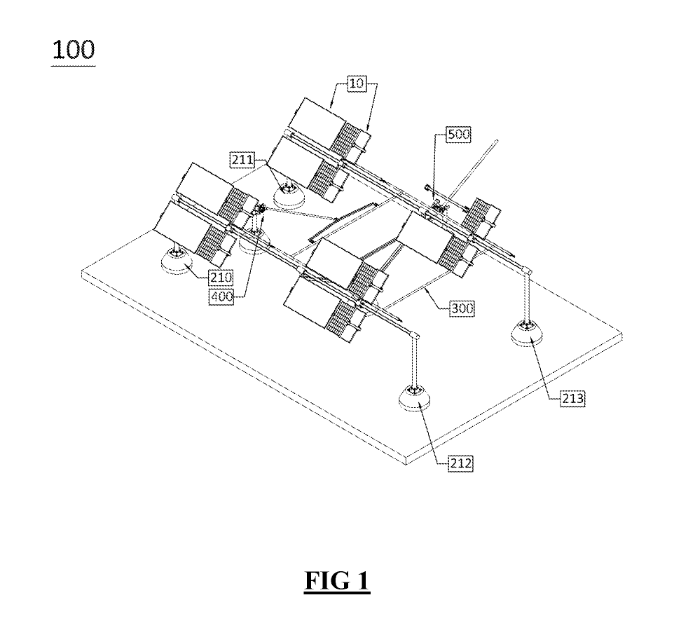

FIG. 1 generally illustrates dual axis tracker (100) for supporting and moving a plurality of solar devices or an array of solar devices in tracking the sun, in one embodiment, comprising at least one pivotal arm (110) for carrying at least one solar device (109 and 10), a support structure (200), a first actuating structure (300), a second actuating structure (350) (not shown in FIG. 1), a first motor (400) and a second motor (500).

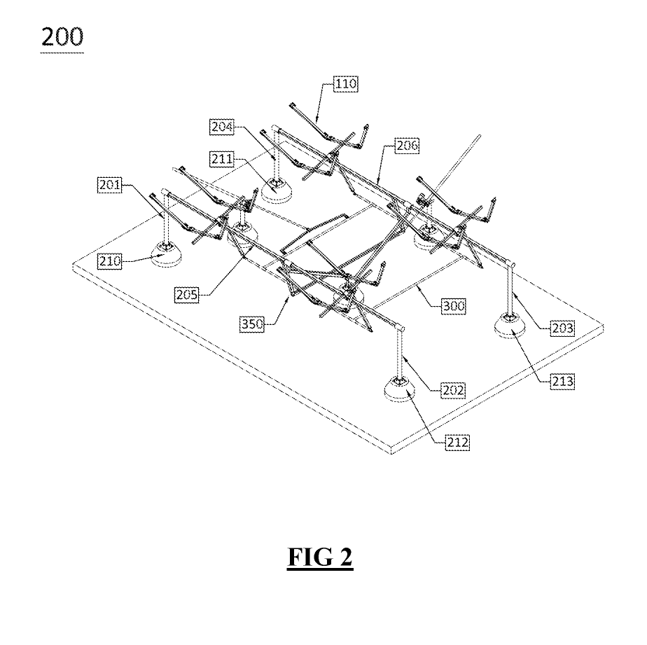

With reference to FIG. 2, the support structure (200) comprises at least four vertical posts (201, 202, 203, 204), positioned in a manner such that they generally define a rectangular or square structure. At least two horizontal posts (205, 206) are secured to the vertical posts (201, 202, 203, 204), whereby in this connection each end of the horizontal post (205, 206) is secured to one vertical post (201, 202, 203, 204). As shown in FIG. 2, the carrier arm (110) or a plurality of pivotal arms (110) are positioned in a manner such that the orientations of the solar device (109 and 10) or a plurality of solar devices (109 and 10) (not shown) are supported and guided by the support structure (200) and the actuating structures (300, 350), which will be described later in further detail herein. All members of the support structure (200) are formed from alloy based materials or suitable materials of the like. Further, these posts can be formed with various cross sections deem suitable to achieve the desired objects of the claimed invention.

The support structure (200) further comprises a plurality of concrete blocks (210, 211, 212, 213) or anchoring means of the likes to serve as foundations for the tracker (100).

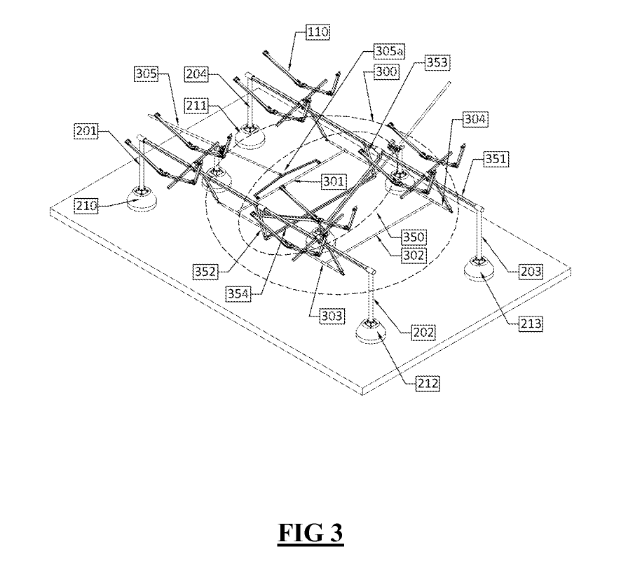

FIG. 3 illustrates the actuating structures according to the preferred embodiments of the claimed invention. The actuating structures (300,350) are adapted to provide movements and thus the orientations of the solar devices (109 and 10) based on the movements provided by the motors (400, 500).

First Actuating Structure

Now referring to FIG. 3, the first actuating structure (300) is formed by a plurality of horizontal members (301, 302, 303, 304), arranged in a manner such that at least two horizontal members (301, 302) referred herein as the transverse posts are secured perpendicularly between the other two horizontal members (303, 304) referred herein as the lateral posts. The horizontal members are generally elongated and can be in the form of tubular posts formed from metallic alloy or suitable materials. On each end of the lateral posts (303,304 may be formed with a flat projection (not shown in FIG. 3) having a mounting hole (not shown in FIG. 3) for pivotal connection with one end of the pivotal arm (110) to be further elucidated in the following paragraphs.

In this embodiment, there is further provided a telescopic boom (305) preferably secured at one section of the first actuating structure (300). The telescopic boom (305) further comprises an inverted U-shaped member (305a) connected to a first motor (400) which is adapted to be accordingly connected to the telescopic boom (305) in a manner such that it can telescopic movement for the boom (305) and thus moving the first actuating structure (300) forward and backward. The first actuating structure (300) may further include a support means, which can be in the form of concrete blocks to support the first motor (400).

In accordance with the preferred embodiments of the claimed invention, at least two of the horizontal members (303, 304) referred herein as lateral posts, of the first actuating structure (300) are pivotally coupled to a plurality of pivotal arms (110), preferably in a manner such that at least one pivotal arm (110) is pivotally coupled to each end of the horizontal member (303, 304).

Second Actuating Structure

With reference to FIG. 3, the second actuating structure (350) comprises at least one elongated horizontal member (351) and two vertical members (352, 353). Similar to that of the first actuating structure (300), the horizontal and vertical members are generally elongated and can be in the form of tubular posts formed from metallic alloy or suitable materials.

In this embodiment, at least one end of each vertical member (352, 353) is pivotally attached to each end of the horizontal member (351). Another end of each vertical member (352, 353) is pivotally secured to the support structure (200), more particularly to the horizontal posts (205, 206) of the support structure (200). Such arrangement therefore generally forms a movable U-shape structure or member (354). A second motor (500) is disposed adjacent to the second actuating structure (350) in a manner such that it is able to move the second actuating structure (350) laterally. The motor (500) is attached or connected to a second telescopic boom (305) in a manner such that the motor (500) can provide telescopic movement to the telescopic boom (305).

It is further contemplated that the support and actuating structures can be of collapsible structures as all members to form these structures can be detachably secured to each other.

Similar to that of the first actuating structure (300), the second actuating structure (350) may further include a support means, which can be in the form of concrete blocks for supporting the second motor (500).

Pivotal Arm

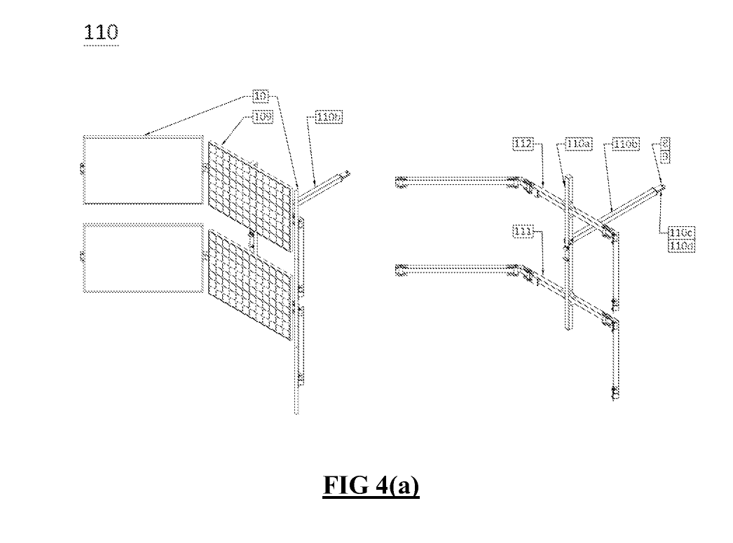

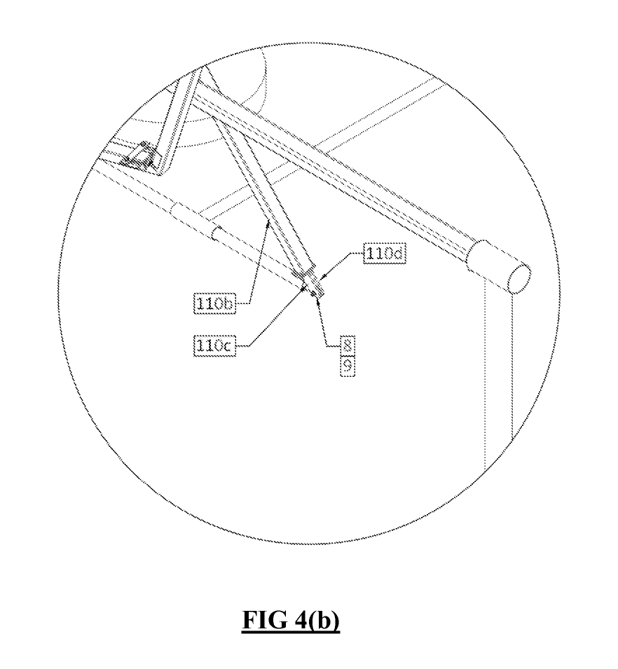

FIG. 4 (a) illustrates the pivotal arm (110) in accordance with the preferred embodiments of the claimed invention.

With reference to FIG. 4 (a), the pivotal arm (110) is in the form of a carrier bar, which may comprise of metallic alloy or composition, or other material suitable for supporting at least one solar device (109 and 10). In this embodiment, the pivotal arm (110) is generally a T-shape member, therefore comprising a vertical bar and a cross bar mounted on said vertical bar. The cross bar being the upper section (110a) of the pivotal arm (110) is adapted for holding the solar device (109 and 10) and the vertical bar being a lower section is adapted for pivotal connection with the first actuating structure (300). The upper section of the pivotal arm (110) further comprising at least two transverse bars (111, 112) disposed on both distal ends of the cross bar. Each of these transverse bars (110a, 110b) serves primarily to for mounting of at least one solar device (109 and 10). Now referring to FIG. 4 (b), at one end of the lower section (110b) of the pivotal arm (110) there is provided a pair of extensions (110c, 110d). The extensions (110c, 110d) can be in the form of flat extensions and are formed with at least one mounting hole (8,9) on each extension. It is understood that the solar device (109 and 10) can be mounted directly on the upper section of the pivotal arm (110) by way of suitable mounting fixture or fastening means. In one embodiment, the upper section of the pivotal arm (110) can be adapted to carry at least two solar devices (109 and 10) and at least two reflecting means (10) or a concentrator means to increase or optimize solar radiation on the panels (109 and 10). It is contemplated that the attachment of solar panels or modules on the pivotal arm (110) may include standard mountings, which are known in the art. In one embodiment, each pivotal arm (110) can hold six solar devices (109 and 10)

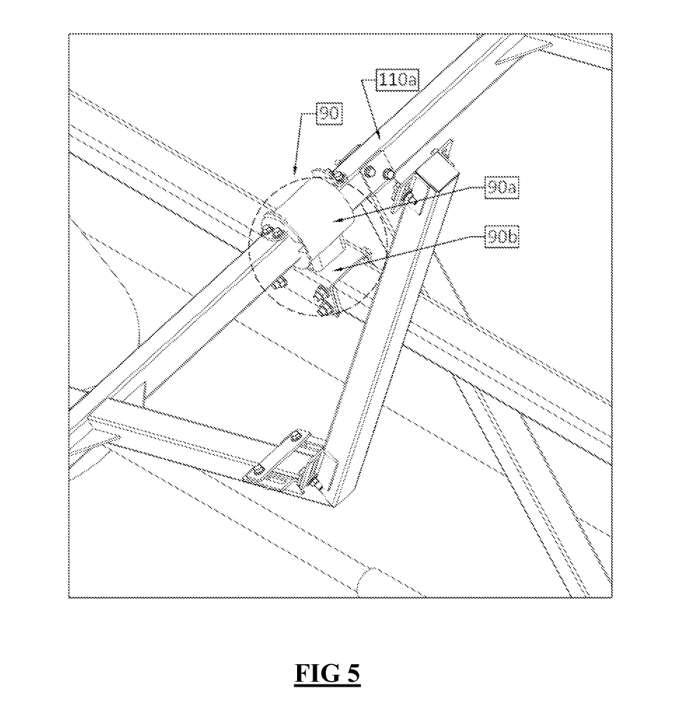

As briefly mentioned, the lower section of the pivotal arm (110) is pivotally coupled to the first actuating structure (300) while the upper section is pivotally coupled to the support structure (200) by way of a perpendicular connector (90). Now referring to FIG. 5, the perpendicular connector (90) may be constructed from metallic alloy or composition, or other suitable material formed preferably into two main sections, a first section (90a) for pivotally holding the upper section of the pivotal arm (110) and a second section (90b) for mounting the upper section of the pivotal arm (110) to the horizontal post (205,206) of the support structure (200). The first section (90a) of the connector (90) comprises suitable bushing means so as to permit rotation of the cross bar of the pivotal arm (110).

Operating Assemblage

When assembled, the two horizontal posts (205, 206) are secured to the vertical posts (201,202,203,204) in a manner such that each end of the horizontal posts (205, 206) is secured to one vertical post (201, 202, 203, 204). In this position, the horizontal posts (205, 206) are mutually opposing each other at a predetermined distance. The lateral horizontal posts (303, 304) of the first actuating structure (300) is disposed in parallel and generally below relative to that of the horizontal posts (205, 206) of the support structure (200). Further, the first motor (400) together with the first telescopic boom (305) is disposed at one end of the first actuating structure (300), also preferably in parallel to that of the horizontal posts (205, 206); wherein the first telescopic boom (305) is secured to one of the transverse posts (301, 302) in a manner such that it is able to drive the first actuating structure (300) forward and backward with the aid of the motor (400).

The second actuating structure (350) is secured in transverse position relative to the horizontal posts (205, 206) of the support structure (200). In this embodiment, the U-shaped member (354) of second actuating structure (350) extends vertically downwards relative to the support structure (200) in manner such that it is able to swing laterally freely without colliding with any part of the first actuating structure (300). Accordingly in this position, the bottom portion of the U-shape member of the second actuating structure (350) extends slightly below the first actuating member (300). The second motor unit (500) is disposed in parallel with the U-shape member of the second actuating structure (350); whereby the telescopic boom (305) is secured to one of the vertical members (352, 353). When the second motor (500) is activated, the U-shape member (354), of the second actuating structure (350); which is pivotally coupled to the support structure (200) is driven laterally thus providing a corresponding tracking movement to the solar devices (109 and 10) in cooperation with the pivotal arms (110).

It is further contemplated that the telescopic booms for both actuating structures may be replaced or substituted with any extensible pole or post, so as to provide a similar technical effect with respect to the objects of the claimed invention.

In accordance with the preferred embodiments of the claimed invention, the pivotal arm (110) is secured in a manner such that the lower section (110b) extends downwardly relative to the support structure (200). The upper section (110a (in FIG. 4(a)) of the pivotal arm (110) is pivotally coupled to the horizontal post (205, 206) of the support structure (200) by way of the perpendicular connector (90) thus permitting the pivotal arm (110) to swing based on the defined axis point. The lower section (110b) of the pivotal arm (110) is pivotally secured to one end of the lateral post (303,304) of the first actuating structure (200).

In one embodiment, each horizontal post (205, 206) of the support structure (200) can support at least two pivotal arms (110); whereby each pivotal arm (110) can hold six solar devices (10); said devices (109 and 10) may comprise of solar panels and reflecting means. Accordingly, the pivotal arms (110) are uniformly spaced apart at a predetermined distance to allow freedom of movements for the solar devices (109 and 10) and reduced shading of adjacent devices.

Notably, with the arrangement of the claimed invention, the orientation of the solar devices (109 and 10) carried by the pivotal arms (110) can be synchronously maneuvered based on the movements of the first and second actuating structures (300, 350).

Dual Axis Movements

The arrangement of the claimed invention allows east-west and north-south orientations of the solar devices (10), whereby the orientations of the solar devices (109 and 10) are in response to the combination of movements provided by the first and second actuating structures (300, 350). Perceptibly, the tracker (100) aids to move the solar devices (109 and 10) in order to catch as much light from the sun.

In operation, the first motion of the solar devices (109 and 10) is based on or translated from the movement of the first actuating structure (300). For the first motion, the first actuating structure (200) is driven forward and backward, powered by the first motor unit (400) thus providing an orientation for the solar devices (109 and 10) based generally on a horizontal axis. The second motion is translated from the lateral movement of the U-shape member (354) of the second actuating structure (350). For the second motion, the second motor unit (500) drives the second telescopic boom (305) which is attached to the side section U-shape member (354); forward and backward thus translating the said movement to an orientation generally based on a vertical axis for the solar devices (109 and 10).

It is further contemplated, and as briefly disclosed in earlier paragraphs, the dual axis tracking system can be used for tracking other astronomical or celestial objects, whereby for such purpose, the astronomical tools can be mounted on the pivotal arms in a manner such that the tools or devices can move in alignment or synchronously during tracking.

Thus, specific arrangements and combinations of a dual axis solar tracker have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A dual axis tracker (100) comprising:
a support structure (200) comprising two horizontal posts (205, 206) and a plurality of vertical posts (201, 202, 203, 204); wherein each end of said horizontal posts (205, 206) are secured to at least one vertical post (201, 202. 203, 204);
at least two pivotal arms (110) mounted to the support structure (200) for holding at least two solar devices (109);
a first actuating structure (300) pivotally mounted to said pivotal arms (110); said first actuating structure (300 comprising a first telescopic boom (305);
a first motor (400) connected to said first telescopic boom (305) for powering the telescopic movement of the telescopic boom (305) and thus providing movement for the first actuating structure (300);
a second actuating structure (350) disposed transversely relative to the first actuating structure (300) and pivotally mounted to the support structure (200); said structure (350) comprising a second telescopic boom (305);
a second motor (500) connected to said second telescopic boom 305) for powering the telescopic movement of the second telescopic boom (305) and thus providing movement for the second actuating structure (350);
wherein the movement of the first actuating structure (300) translates a first motion for the solar devices (109 and 10) and the movement of the second actuating structure (350) translates a second motion for the solar devices (109 and 10).

2. The tracker as claimed in claim 1 wherein the first actuating structure (300) comprises further at least two lateral posts (303, 304) and two transverse posts (301,302) secured in between said lateral posts (303, 304).

3. The tracker as claimed in claim 1 wherein the second actuating structure (350) comprises plurality of horizontal and vertical posts pivotally connected in manner such that they generally form a U-shaped member (354).

4. The tracker as claimed in claims 1 to 2 wherein the first telescopic boom (305) is secured to at least one of the transverse posts (301, 302) of the first actuating structure.

5. The tracker as claimed in claims 1 to 3 wherein the second telescopic boom (305) is secured to a side section of the U-shaped member (354).

6. The tracker as claimed in claim 1 wherein the first motor (400) provides forward and backward movement for the first actuating structure (300); and the second motor provides a lateral movement for the second actuating structure (350).

7. The tracker as claimed in claims 1 to 3 wherein the U-shaped member (354) of second actuating structure (350) extends vertically downwards relative to the support structure (200) in manner such that it is able to swing laterally freely without colliding with any part of the first actuating structure (300).

8. The tracker as claimed in claim 7 wherein the bottom portion of the U-shaped member (354) is positioned slightly below the first actuating structure (300).

9. The tracker as claimed in claim 1 wherein said tracker (100) further comprising a plurality of concrete blocks (210, 211, 212, 213).

10. The tracker as claimed in claim 1 wherein the first actuating structure (300) is connected to a lower end of the pivotal arm (110).

11. The tracker as claimed in claim 1 wherein synchronized movements for the solar devices are provided with the collaboration of the first and second actuating structures (300,350).
